(19) United States
(12) Patent Application Publication
(10) Pub. No.: US 2020/0032860 A1
(43) Pub. Date: Jan. 30, 2020

(54) A Low Speed, Bi-Directional Expanding or Compressing Reactive Clutch

(71) Applicant: Bair-Ling Technologies, LLC, La Mesa, CA (US)

(72) Inventors: Donald Lane Bair, La Mesa, CA (US); Rodric Niles Lingren, La Mesa, CA (US)

(73) Assignee: Bair-Ling Technologies, LLC, La Mesa, CA (US)

(21) Appl. No.: 16/497,608

(22) PCT Filed: Mar. 27, 2018
(86) PCT No.: PCT/US18/24463

§ 371 Date: Sep. 25, 2019

Related U.S. Application Data
(60) Provisional application No. 62/476,868, filed on Mar. 27, 2017.

(51) Int. Cl. F16D 41/063; F16D 43/21

(52) U.S. Cl. CPC F16D 41/063; F16D 43/211

(57) ABSTRACT

We disclose a novel family of mechanical bi-directional speed sensing clutches that use Reactive Intermediate Elements with interlocking wedging ramps, in a first element, corresponding to similarly shaped interlocking wedging ramps in a second element. Such that when said first and second elements are counter-rotated compression or expansion occurs to provide torque-transfer.

### RELATED APPLICATION

This Patent Cooperation Treaty application incorporates by reference the disclosures of PCT/US2014/056605 A Torque-Limiting System, and Provisional Application 62/476,868, Mar. 27, 2017, A Bi-Directional Radial Clutch, without admitting them to be prior art.

### BACKGROUND OF THE INVENTION

It is known to the art that a speed-sensitive clutch has an input, a clutching mechanism to transfer torque and an output, and that relative motion, acceleration or deceleration, between the input and output causes engagement.

Many types of speed sensitive, locking and freewheeling clutches are known to the art. Centrifugal clutches have an engagement range rpm that is high, minimum of 800 rpm, for many applications and Sprag clutches, Over-running clutches or One-way bearings instantly engage and disengage at zero rpm, neither of which are optimal many circumstances.

It can be understood from the cited PCT application that BT-B has bi-directional wedging ramps in the bore of a cylinder or on the exterior surface of a shaft between and directly contacting the corrugations of a tolerance ring, known to the art. When said bi-directional wedging ramps are counter-rotated BT-B can provide reactive mechanical, bi-directional torque transfer at a chosen rpm. Tolerance rings, known to the art, have one or more rows of closed end corrugations separated by a flat between each one and can be split rings, known to the art, or a segmented rings with one or more segments. Tolerance rings have a “pitch”, known to the art, which is the distance between the centers of said corrugations related to a diameter.

However as tolerance rings wear, the pitch, slightly changes which can reduce the efficiency of said BT-B. Thus there is a need for a new device that uses the principals of BT-B but maintains said corrugation pitch for the life of a vehicle or device. Thus there is a need for the present invention.

### SUMMARY OF THE INVENTION

The present invention is a novel family of mechanical, bi-directional speed sensing clutches that use Reactive Intermediate Elements with interlocking wedging ramps, in a first element, corresponding to similarly shaped interlocking wedging ramps in a second element. Such that when said first and second elements are counter-rotated compression or expansion occurs to provide torque-transfer.

Embodiments of the present invention have inter-nesting, bi-directional wedging ramps in the bore or on the exterior surface of a shaft, and thence between the surface of an RIE, Reactive Intermediate Element which then contacts a tolerance ring, or frictional material, to provide torque transfer.

RIE is bi-directionally torque-transferring during CW and CCW rotation, as in forward and reverse, and, as stated, can also be configured to provide torque-transfer in either of two radial directions, compressing (around an internal shaft) or expanding (inside the bore of a cylinder). It is therefore understood that RIE is bi-directional and compressing or bi-directional and expanding. RIE will be further explained and Illustrated.

It is understood that said tolerance ring can solely provide a frictional surface between RIE and said shaft or bore or; said tolerance ring can include a frictional material on its torque-transferring surface, or; that RIE can solely use said frictional material between its torque-transferring surface and said shaft or bore, without limitation. Said frictional material can be any torque-transferring material, know to the art including those commonly used in brakes, wet and dry clutches and Limited-Slip Differentials without limitation.

It is understood that said engagement speed is a fixed number within a range of possibilities which can be chosen for optimum performance, without limitation.

Said tolerance ring can be a split ring, known to the art, or a segmented ring with one or more segments or may have a single segment, with a single corrugation, for each grove or ramp of CVTL or BT-B. It is understood that a single segment with a single corrugation for each grove or ramp can float to maintain perfect pitch alignment as parts wear.

It is understood that RIE can have a depth stop that limits compression of said tolerance ring to chosen parameters and that said depth stop can increase the torque-transferring surface area that RIE provides over CVTL, BT-B or known to the art tolerance ring applications, and reduce wear.

It is understood that RIE can have rotational stops that are effective in both CW and CCW rotational directions and that said rotational stops can limit the counter-rotation of RIE and thus compression of said tolerance ring to chosen parameters.

It is understood that RIE is ring shaped and can have one or more splits, or have one or more segments and can have relief cuts that allow said split ring or said segments to flex which can provide even compression as parts wear and circumferences change.

It is understood that RIE only has to rotate a small fraction of a circle in either direction so lock time is immediate.

It is understood that the characteristics of RIE including, the profiles of said wedging ramps, frictional coefficients, pre-load, depth stop parameters, radial stop parameters, tolerance ring and frictional material characteristics, determine the static torque, speed and duration of engagement, and torque transfer and limitation values, without limitation.

It is understood that both input, an external component, and output, a shaft, of the Present Invention, without limitation, can have any means of attachment known to the art, to any necessary component or driving or driven component, or prime mover, without limitation, including splines, keys, adhesives, pins, bolts, stamping, blanking, welding, 3D printing, CNC machining etc. without limitation.

Regarding this disclosure, for purposes of simplicity, it is understood that said input shall be exterior component 110, said clutch shall include Embodiments of the present invention, including 200, 201, 202, 203, 204, 205, 300, 301, 302; and said output shall be shaft 3. It is specifically understood by those in the art, that that the input and output can be configured in reverse order and are without limitation in any way.

Said Embodiments of the present Invention are related to and hereby cite and include by reference PCT/US2014/056605 and its Embodiments including BT-B, with Bi-directional wedging ramps, and CVTL, a Constant Value Torque-limiter. And Provisional Application 62/476,868 A Bi-Directional Radial Clutch, without admitting them to be prior art.

There are few simple, inexpensive, durable mechanical clutches know to the art that can engage at very low revolutions per minute, under 100 rpm and provide significant foot pounds of torque transfer thus it is understood the there is a need for the present invention.

### A BRIEF DESCRIPTION OF THE DRAWINGS

FIG. 1 shows Embodiment 200 a bi-directional compressing speed sensitive clutch with an RIE, Reactive Intermediate Element and a CVTL.

FIG. 2 shows Embodiment 200 with no compression or counter-rotation.

FIG. 3 shows Embodiment 200 with counter-rotation and compression.

FIG. 4 shows Embodiment 300 a bi-directional expanding speed sensitive clutch with an RIE, Reactive Intermediate Element and a CVTL.

FIG. 5 shows Embodiment 201, a bi-directional compressing speed sensitive clutch, with a frictional material transferring torque.

FIG. 6 shows Embodiment 202, a variant ramp configuration with bi-directional rotational compression stops.

FIG. 7 shows a section view of one segment of multi-segmented tolerance ring 1b, with corrugation 1g and flat 1z.

FIG. 8 shows Embodiment 203, RIE depth stop, in uncompressed mode.

FIG. 9 shows Embodiment 203, RIE depth stop, in compressed mode.

FIG. 10, shows Embodiment 204, a Drop-in, reactive LSD, with Embodiment 200 and a Sprague Type front differential of a Polaris® ATV-UTV-ROV.

FIG. 11 shows Embodiment 205 a Limited-Slip Axle system with Embodiments 200 in the half-shafts of a rear axle of a Polaris®ATV-UTV-ROV.

### A DETAILED DESCRIPTION OF THE DRAWINGS

Explaining Embodiments of the present invention including the compressing family of Embodiment 200; the expanding family of Embodiment 300; Embodiment 202, a variant ramp configuration with bi-directional rotational compression stops, Embodiment 203 a RIE depth stop and examples of industrial applicability Embodiments 204 and 205.

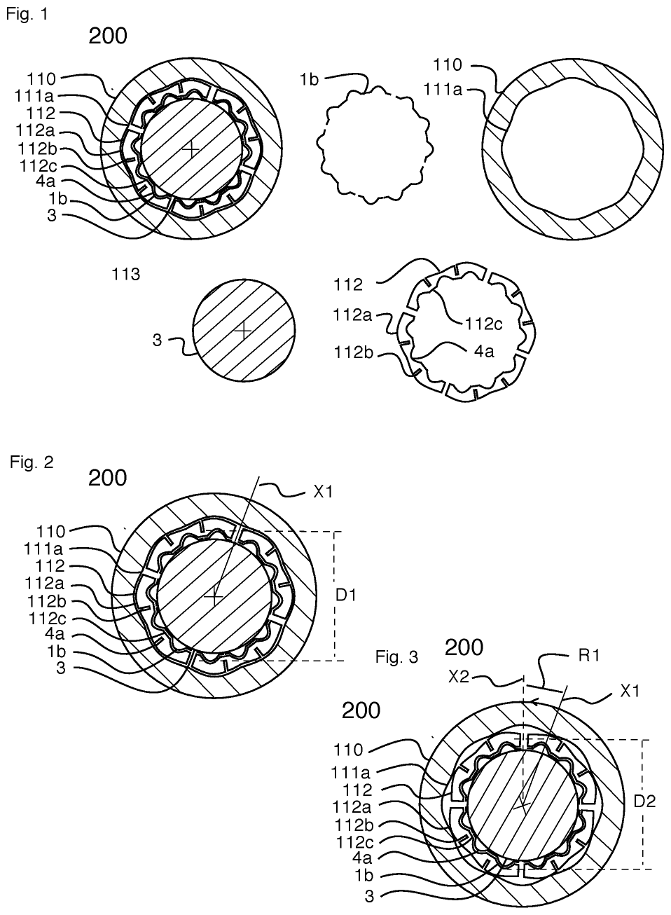

FIG. 1 shows Embodiment 200 a bi-directional compressing speed sensitive clutch in assembled and disassembled sectional views with an RIE, Reactive Intermediate Element and a CVTL. With external component 110, bore ramp 111a, RIE 112, RIE ramp 112a, RIE relief cut 112b, RIE depth stop 112c, CVTL groove 4a, multi-segmented tolerance ring 1b, shaft 3. It is understood that multi-segmented tolerance ring 1 and groove 4a form CVTL. CVTL is a Constant Value Torque-Limiter described in PCT/US2014/056605.

It can be seen that 200 is a compressing device using RIE to compress multi-segmented tolerance ring 1b and provide torque-transfer around a shaft. And that counter rotation, between external component 110 and RIE, caused by relative rotational acceleration or deceleration between shaft 3 and external component 110, will cause said 200 to compress and cause torque transfer to multi-segmented tolerance ring 1b, or not shown, any tolerance ring know to the art or a frictional material, without limitation.

FIG. 2 and FIG. 3 show sectional assembled views of Embodiment 200 in uncompressed and compressed modes, and how counter-rotation causes torque-transfer. Showing, uncompressed position X1, degree of rotation R1, compressed position X2, uncompressed dimension D1, compressed dimension D2, external component 110, bore ramp 111a, RIE 112, RIE ramp 112a, RIE relief cut 112b, RIE depth stop 112c, CVTL groove 4a, multi-segmented tolerance ring 1b, shaft 3.

Comparing FIG. 2 and FIG. 3, It can be seen that counter-rotation between position X1 and X2 results in angle R1 which shows counter-rotation which causes compression of RIE and D2 becoming smaller that D1.

FIG. 2 shows Embodiment 200 with no compression or counter-rotation at position, X1, because no relative motion between exterior component 110, and RIE 112, has occurred, and D1 which shows that there is no compression of tolerance ring 1b and thus no torque transfer.

FIG. 3 shows Embodiment 200 with counter-rotation and compression between external component 110 and RIE 112. RIE has moved to X2 by angle R1. D2 is now smaller than D1. It is understood that torque-transfer now occurs between multi-segmented tolerance ring 1 and shaft 3. It can be seen that torque-transfer occurs quickly because RIE has a small fraction of a circle to travel. It is understood that FIG. 1, FIG. 2, and FIG. 3 show Embodiment 200 functioning in CCW direction and that Embodiment 200 functions in the same manner in CW direction.

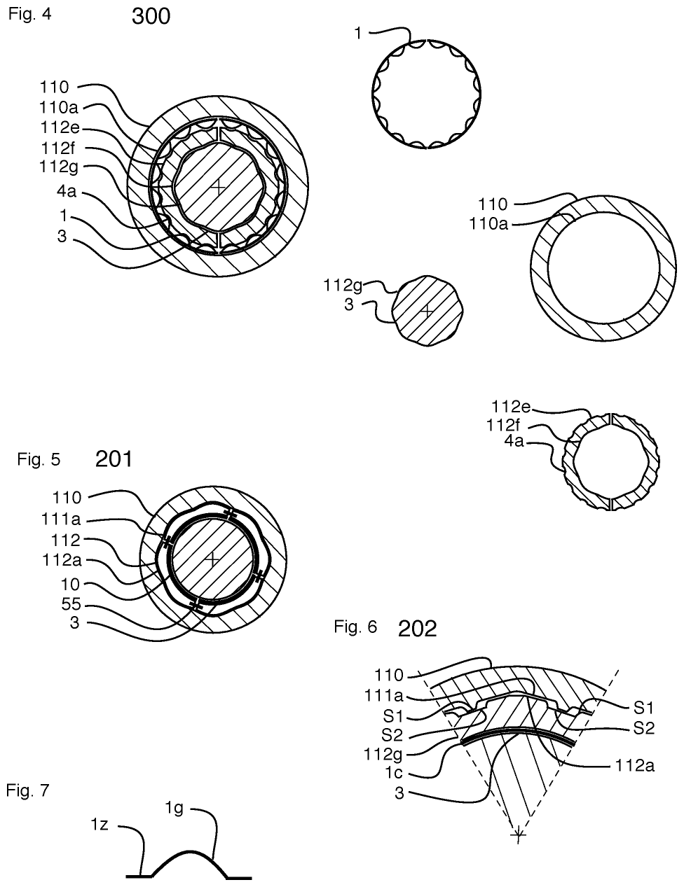

FIG. 4 shows Embodiment 300 a bi-directional, expanding speed sensitive clutch in assembled and disassembled sectional views with an RIE, Reactive Intermediate Element and a CVTL, re-configured for expansion. With, external component 110, bore surface 110a, tolerance ring 1, expanding RIE 112e, expanding RIE bore ramp 112f, CVTL groove 4a, expanding RIE ramp 112g, shaft 3, It is understood that Tolerance ring 1 and groove 4a form CVTL.

It can be seen that Embodiment 300 employs an expanding version of RIE to compress tolerance ring 1, and provide frictional torque-transfer to bore surface 110a, of external component 110. And that relative motion, between external component 110 and RIE, caused by relative rotational acceleration or deceleration between shaft 3 and external component 110, will cause said Embodiment 300 to to engage and compress tolerance ring 1, or (not shown) any tolerance ring known to the art or a frictional material, without limitation.

It is further understood that Embodiment 300 can include, RIE relief cut 112b, RIE depth stop 112c and multi-segmented tolerance ring 1a. It can be seen that RIE 112x, is inside-out in relation to RIE 112 in 200, with RIE bore ramp 112e, on its interior surface and CVTL groove 4a on its exterior surface, and that shaft 3, has expanding ramp 112f on its exterior surface. It can therefore be seen that Embodiment 300 is bi-directional and expanding.

FIG. 5 shows Embodiment 201, in sectional view, a bi-directional compressing speed sensitive clutch with a frictional material in place of a tolerance ring with, external component 110, bore ramp 111a, RIE 112, RIE ramp 112a, frictional material 10, wave spring 55, shaft 3.

It is understood that Embodiment 201 functions in the same manner as Embodiment 200, such that relative rotational acceleration or deceleration causes compression and torque-transfer.

Wave springs 55, known to the art, between the ends of RIE 112 provide a frictional drag between the external component 110 and shaft 3. and act as a release mechanism after compression has occurred. Said frictional material is used to provide a torque-transferring surface and can be any organic or inorganic torque-transferring material, know to the art including those commonly used in brakes, wet and dry clutches and Limited-Slip Differentials without limitation.

FIG. 6 shows Embodiment 202, a variant ramp configuration with bi-directional rotational compression stops, in partial, sectional view. Showing external component 110, bore ramp 111a, stop S1, stop S2, RIE 112g, RIE ramp 112a, and 1c, which can be any tolerance ring known to the art, or multi-segmented tolerance ring 1b or a frictional material, shown, shaft 3.

It can be seen that Embodiment 202 has two rotational compression stops, S1 and S2, that can limit the relative rotation between external component 110, and RIE 112, and thus limit travel and protect against over-rotation. Said 12a can also clamp after partial rotation and theres ore will have wear compensation characteristics. Torque-transfer limitation occurs by controlling the coefficient of Friction between the torque transferring surface, a tolerance ring or friction surface and the bore or shaft.

It is understood that Embodiment 202 can be applied to one or more Embodiments of the present invention including the compressing family of Embodiment 200 and the expanding family of Embodiment 300.

FIG. 7 shows a sectional view of one segment of multi-segmented tolerance ring 1b, with corrugation 1g and flat 1z.

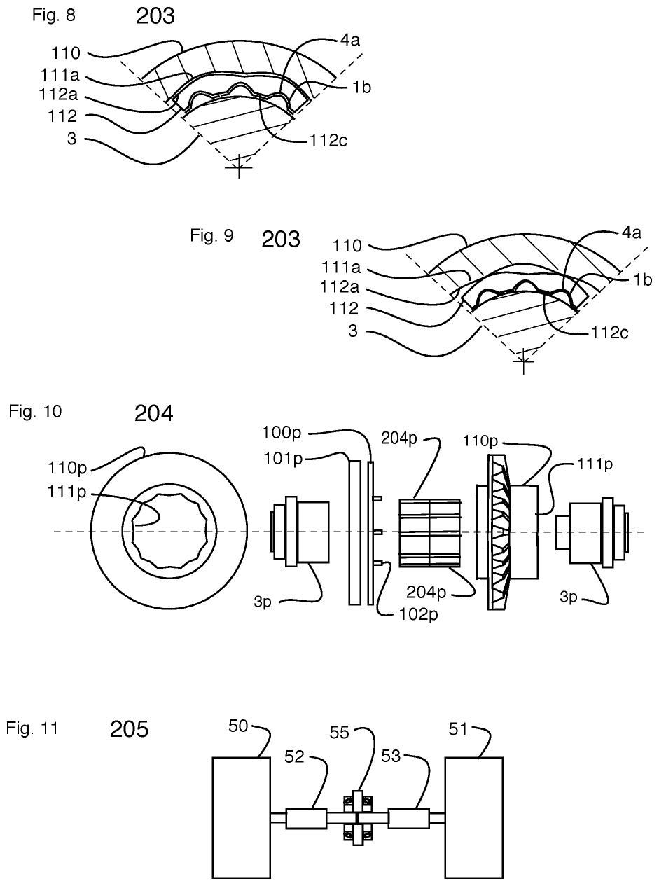

FIG. 8 and FIG. 9 show Embodiment 203 and how RIE depth stop functions.

FIG. 8 shows Embodiment 203 an RIE depth stop, in uncompressed mode, in partial section view. With external component 110, bore ramp 111a, RIE ramp 112a, RIE 112, RIE depth stop 112c, CVTL groove 4a, multi-segmented tolerance ring 1b, shaft 3. RIE relief split 112b not shown.

FIG. 9 shows Embodiment 203, RIE depth stop, in compressed mode, a partial section view. With external component 110, bore ramp 111a, RIE ramp 112a, RIE 112, RIE depth stop 112c, CVTL groove 4a, multi-segmented tolerance ring 1b, shaft 3. RIE relief split 112b not shown.

Tolerance rings, know to the art, generally consist of a split ring of metal with closed end corrugations, 1g, at regular intervals and flats 1z, FIG. 8, in between each corrugation. Each corrugation acts as a stiff spring, so it can be understood by those in the art, that the amount each corrugation is compressed, times the number of corrugations and the frictional coefficients of the elements, determines the torque transfer value that said tolerance ring can provide. It can also be understood that over-compression can damage said corrugations of said tolerance ring and under-compression can provide a poorly performing device. Therefore a method to control the compression by depth stop 112c, is necessary for optimal performance and longevity.

As explained in FIGS. 1, 2 and 3, it can be seen that as Embodiment 200 counter-rotates and RIE 112, is compressed against multi-segment tolerance ring 1b and shaft 3. And that the depth of groove 4a can control the compression on a corrugation of any tolerance ring, without limitation, by a chosen percentage or dimension. Because when RIE depth stops 112c, contact tolerance ring flats 1z, said depth stops press on the surface of shaft 3 and compression of said corrugation stops at a chosen parameter. However compression can continue against tolerance ring flats 1z.

Therefore said RIE depth stop 112c, increases the torque-transfer area by including the area of the flats in compression against the surface of a shaft or a bore. Said event increases surface area, increasing total torque-transfer and decreasing wear.

FIG. 10 and FIG. 11 show examples of industrial applicability for Embodiments 204 and 205. Both, for simplicity, show the use of Embodiment 200, but it is understood that any configuration or combination of the Embodiments of the present invention can be used without limitation.

FIG. 10, Embodiment 204, is a Drop-in, reactive LSD, composed of parts of Embodiment 200 and existing parts of the Sprague-type front differential of a Polaris® Demand-Drive ATV-UTV-ROV. Showing the ring gear, parts of the front differential of a Polaris® ATV-UTV-ROV and clutch 204p in front and side views.

Showing, ring gear 110p, Polaris bore ramp 111p, drive hub 3p, armature plate 100p, armature 101p, drive tabs 102p, clutch 204p (each clutch 204p can contain one or more Embodiments 200, 201, 202, 300, 301 and CVTL and BT-B without limitation) ring gear 110p, Polaris bore ramp 111p, drive hub 3p. It is understood that clutch 204p contains a pair of Embodiment 200′s, without limitation. It is understood that, armature plate 100p, armature 101p, drive tabs 102p compose the semi-active part of the Polaris ATV-UTV-ROV Demand Drive system.

It can be seen that said Polaris® ATV-UTV-ROV front differential has a ring gear 110p, with grooved bore 111p, and thus can act as, Embodiments 200's external component 110 and bore ramp 111a. And said front differential has output hubs 3p, that can function as shaft 3. And said output hubs 3p are connected to road wheels, not shown,

Therefore it is understood that a pair of Embodiment 200's, without limitation, with their external components, 110 and bore ramps 111a removed and placed in Polaris ATV-UTV-ROV bore ramp 111p, inside ring gear 110p, and shaft 3 replaced by drive hubs 3p can function as a one in-two out clutch to transfer torque.

It can be further understood that that the remaining parts of Embodiment 200, consisting of RIE 112, RIE ramp 112a, RIE relief cut 112b, RIE depth stop 112c, CVTL groove 4a, multi-segmented tolerance ring 1b, can be configured to “drop-in” and replace the existing internal parts of Polaris ATV-UTV-ROV front differential, without limitation. It can be seen that the preceding operation creates clutch 204p.

It is understood that torque enters said front differential from the Polaris ATV-UTV-ROV power-train and is transferred by said clutch 204p separately to both output hub 3p's, and thence to said road wheels. It is also understood that there is one input through said ring gear 110p, and two outputs through said clutch 204p.

It is therefore understood that Embodiment 204 functions as a pair of mechanical speed sensing clutches by reacting to acceleration and deceleration, and as an LSD by allowing differentiation as said road wheels transit a corner while still transmitting power from the engine and still limiting unwanted differentiation for said all Polaris®ATV-UTV-ROV models.

It is understood that Polaris® ATV-UTV-ROV's have a semi-active Demand-Drive System and that Embodiment 204 can be configured to be activated by it. Armature plate 100p, armature 101p, drive tabs 102p essentially replace the function of frictional pre-load discussed in the Embodiments of the present invention. Drive tabs 102p are engaged to the body of clutch 204p and when armature 101p is activated, magnetic force holds armature plate 100p to said armature plate 101p. This creates drag on clutch 204p and facilitates engagement.

FIG. 11 shows Embodiment 205 a Limited-Slip Axle system with a clutch 205p shown in both the half-shafts of a rear axle of a Polaris®ATV-UTV-ROV in plan view. Said Polaris OEM rear axle contains a spool, half-shafts and road wheels, known to the art.

Showing Left road wheel 50, right road wheel 51, left clutch 205p-53, right clutch 205p, spool 55. it is understood that each clutch 205p can contain one or more Embodiments 200, 201, 202, 203, 300, 301, and CVTL and BT-B)

It is understood that all Polaris® ATV-UTV-ROV's, produced to date have a rear axle consisting of a spool, and half shafts, with CV joints at each end (not shown), connecting said spool to each rear road wheel. Embodiment 205 can have, one or more clutch 205p's, without limitation, placed in each half shaft between the input, which is the spool and the output, which is the road wheel. It is understood that each said clutch 204p placed in each said half shaft can allow the drive wheels of said Polaris ATV-UTV-ROV, or any vehicle with a spool, to differentiate, travel at different speeds, as the vehicle transits a corner while still transmitting power from the engine and still limiting unwanted differentiation. It is understood that Embodiment 205 uses the same principals, and has the same functionality as Embodiment 204.

### CONCLUSION

All disclosures of the present invention are without limitation in any way.

Said frictional material is used to provide a torque-transferring surface and can be any organic or inorganic torque-transferring material, know to the art including those commonly used in brakes, wet and dry clutches and Limited-Slip Differentials without limitation, which are

It is understood that one or more Embodiments of the present invention can function in all ATV-UTV-ROV, Light Vehicles, cars and trucks, Commercial and Heavy and off highway vehicles, without limitation as a Limited-Slip Differential, LSD in front, center or rear differentials or in half-shafts, in front, center or rear axles, without limitation. That there can be other possible applications unforeseen at this time that apply to all ATV-UTV-ROV type vehicles and their front, center or rear differentials that are hence covered by inference without limitation. It is also understood that one or more Embodiments of the present invention can be placed in any vehicle or machine having a front, center or rear differential and provide an LSD, without limitation.

All examples of specification, design, concept, configuration, placement, use, and function in this specification are understood to be without limitation.

It is also understood that all examples of product specification, design, concept, configuration, placement, use, and function in these disclosures are incorporated into this Specification by reference and are understood to be without limitation in any combination.

It is understood that the components of the Embodiments disclosed herein can be made from any material know to the art, including metals, plastics, ceramics, composites, or any other natural or man made materials, without limitation, by any process or method known to the art such as casting, molding, forging, broaching, stamping, rolling, embossing, blanking, welding, EDM, 3D printing, CNC machining etc. without limitation.

1.-9. (canceled)

10. A clutch comprising:
a first drive member rotatable around an axis of rotation, the first drive member having circumferentially spaced ramps,
a second drive member rotatable around the axis of rotation,
a tolerance ring positioned coaxially with and frictionally engagable with the second drive member, the tolerance ring having circumferentially spaced corrugations extending from adjacent the second drive member toward the first drive member, and a surface between two of the tolerance ring ramps, the tolerance ring surface frictionally engagable with the second drive member,
an intermediate element positioned coaxially with the drive members, the intermediate member having a first series of circumferentially spaced ramps frictionally engaged with the first drive member, and a second series of circumferentially spaced ramps engaged with the tolerance ring corrugations,
wherein relative rotation between the first and second drive members is inhibited when the first drive member is rotated relative to the intermediate element to cause the intermediate element to assert force against the tolerance ring to increase frictional force between the tolerance ring and the second drive member.

11. The clutch as defined in claim 10 wherein the second drive member is a shaft and the first drive member is an annular member surrounding the shaft, wherein the intermediate member is compressed against the tolerance ring when the first drive member is rotated relative to the intermediate element.

12. The clutch as defined in claim 11 wherein the annular member has a radially inner annular surface and wherein the circumferentially spaced ramps are on the annular surface.

13. The clutch as defined in claim 12 wherein the shaft has a smooth outer surface.

14. The clutch as defined in claim 13 wherein the tolerance ring corrugations extend radially outwardly.

15. The clutch as defined in claim 14 wherein each of the tolerance ring and the intermediate member are multi-piece split rings, wherein each piece of the tolerance ring is in mating engagement with a piece of the intermediate member.

16. The clutch as defined in claim 14 wherein the intermediate member is a multi-piece split ring.

17. The clutch as defined in claim 10 wherein the first drive member is a shaft and the second drive member is an annular member surrounding the shaft, wherein the intermediate member is expanded against the tolerance ring when the first drive member is rotated relative to the intermediate element.

18. The clutch as defined in claim 17 wherein the shaft has an outer surface and wherein the circumferentially spaced ramps are on the outer shaft surface.

19. The clutch as defined in claim 18 wherein the annular member has a smooth inner surface smooth radially inner surface.

20. The clutch as defined in claim 19 wherein the tolerance ring corrugations extend radially inwardly.

21. The clutch as defined in claim 10 wherein the force asserted against the tolerance ring is created by relative rotation of the first drive member and the intermediate element in either the clockwise or counterclockwise direction, whereby the clutch is bi-directional.

22. The clutch as defined in claim 10 wherein the intermediate member has an arcuate depth stop to engage the tolerance ring surface after predetermined compression of the intermediate member.

23. The clutch as defined in claim 10 wherein the intermediate member has a radial relief cut to facilitate bending.

24. The clutch as defined in claim 10 wherein the intermediate element includes a radially extending rotational stop, and wherein one of the first and second drive members includes a radially extending rotational stop engagable with the intermediate member rotational stop.

25. A clutch comprising:
a first drive member rotatable around an axis of rotation, the first drive member having circumferentially spaced ramps,
a second drive member rotatable around the axis of rotation,
a friction member frictionally engaging the second drive member,
an intermediate element positioned coaxially with the drive members, the intermediate member having a first series of circumferentially spaced ramps frictionally engaged with the first drive member, the intermediate member radially drivingly engaged with the friction member,
wherein relative rotation between the first and second drive members is inhibited when the first drive member is rotated relative to the intermediate element to cause the intermediate element to assert force against the friction member to increase frictional force between the friction material and the second drive member.

26. The clutch as defined in claim 25 wherein the friction member is a tolerance ring.

27. The clutch as defined in claim 25 wherein the intermediate element includes a radially extending rotational stop, and wherein one of the first and second drive members includes a radially extending rotational stop engagable with the intermediate member rotational stop.

28. The clutch as defined in claim 25 wherein the intermediate element has a plurality of circumferentially spaced segments, and wherein a wave spring connects two of the segments.

29. The clutch as defined in claim 25 wherein the force asserted against the friction member is created by relative rotation of the first drive member and the intermediate element in either the clockwise or counterclockwise direction, whereby the clutch is bi-directional.
